(19) United States
(12) Patent Application Publication
(10) Pub. No.: US 2024/0106179 A1
(43) Pub. Date: Mar. 28, 2024

(54) PRESSING TOOL

(71) Applicant: Weidmüller Interface GmbH & Co. KG, Detmold (DE)

(72) Inventors: Thilo BRÖKER, Detmold (DE); Detlev HETLAND, Detmold (DE); Günther HANNING, Detmold (DE); Christian HEGGEMANN, Detmold (DE); Siegfried STORM, Schlangen (DE)

(21) Appl. No.: 18/257,447

(22) PCT Filed: Dec. 14, 2021
(86) PCT No.: PCT/EP2021/085755

§ 371 Date: Jun. 14, 2023

(30) Foreign Application Priority Data
Dec. 17, 2022 (DE) 10 2020 133 954.2

(51) Int. Cl. H01R 43/042; B25B 27/14

(52) U.S. Cl. CPC H01R 43/042; B25B 27/146

(57) ABSTRACT

A pressing tool has two grips movable relative to one another, a crimping unit with a crimping drum arranged in a tool head of the pressing tool and having at least one crimping die and a depository for storing a strip of ferrules connected to one another as a belt. The tool also includes a transport device movable in a prestressed manner toward the crimping drum to transport the ferrule strip from the depository toward the crimping drum. The transport device has a transport plate and a transport lever pivotably arranged and sprung relative to the transport plate. The transport lever has an attachment close to the crimping drum that can be pressed in between adjacent ferrules there arranged. The attachment is arranged between the transport device and a support surface of a head cap. There is a holding-down device which is spring supported on the support surface and which presses the transport plate against the transport lever.

This application is a § 371 National stage entry of international patent application No. PCT/EP2021/085755 filed Dec. 14, 2021 which claims priority of patent application No. DE 10 2020 133 954.2 filled Dec. 17, 2020. The entire content of these applications is incorporated herein by reference.

### BACKGROUND OF THE INVENTION

The present invention relates to a pressing tool, in particular for crimping a conductor cable.

Numerous embodiment variants of generic pressing tools are known from the prior art, for example from DE 43 22 856 C1.

The tool described in this document, with two grips, which are movable relative to one another, and a crimping unit, which has a number of crimping dies of different diameters and which is arranged in a tool head, has proven its worth in practice.

To supply respective ferrules, which are applied onto a stripped end of a conductor cable during a crimping process, the tool of DE 43 22 856 C1 has a transport device with a transport plate and a transport lever. The device is pivotably arranged in a sprung fashion relative to the transport plate. A ferrule strip mounted in a depository in an upper grip is moved toward the crimping drum. A foremost ferrule of the ferrules is conveyed into the crimping die and then the ferrule is detached from the rest of the ferrule strip by a separator.

Depending on the diameter of the ferrules, it is necessary to set this transport device to the size of the ferrules.

There is a need of a pressing tool that does not require the transport device be set to the respective size of the ferules.

### SUMMARY OF THE INVENTION

Accordingly, one object of the present disclosure is to provide a pressing tool having two grips which are movable relative to one another.

The pressing tool furthermore has a crimping unit with a crimping drum arranged in a tool head of the pressing tool, with the crimping drum having at least one crimping die. The crimping unit furthermore has a depository for storing a strip of ferrules connected to one another as a belt.

A transport device of the pressing tool, movable in a prestressed manner toward the crimping drum, serves to transport the ferrule strip from the depository toward the crimping drum.

The transport device has a transport plate and a transport lever, which is pivotably arranged and sprung relative to the transport plate and which has an attachment close to the crimping drum that can be pressed in between adjacent ferrules.

Between the transport device and a support surface of a head cap of the tool head, a holding-down device is arranged. The device is spring supported on the support surface and presses the transport plate against the transport lever.

By arranging such a holding-down device, a pressing tool is provided in which setting the transport device to the size of the ferrules takes place virtually automatically.

According to an embodiment, the holding-down device has a spring-retaining web on which there is retained a spring element which is supported on the support surface of the head cap.

According to another embodiment, this spring element is a compression spring placed over a spring retainer as a protrusion and retained on the spring-retaining web.

In an alternative embodiment, the spring element is a leaf spring, which is retained on the spring-retaining web via a spring retainer configured like a bracket.

These embodiments of spring elements enable an inexpensive and reliable setting of the transport device to the respective diameters of the ferrules.

According to a further embodiment, the holding-down device has at least one arm which abuts on the ferrule that is adjacent to the ferrule to be detached when the transport device is in a ferrule detachment position close to the crimping drum.

As a result, the second-foremost ferrule of the ferrule strip is pressed onto the depository track on which the ferrule strip rests and cannot be lifted during a separation process by introducing a knife between the two foremost ferrules, irrespective of the diameter of the ferrules.

According to a preferred embodiment, the holding-down device has two arms of different length, wherein the spacing between the arms is of such a size that a press-on surface of a shorter arm can press onto a shell surface of a sleeve head and a press-on surface of a longer arm can press onto a shell surface of a sleeve neck of the ferrule.

According to a further embodiment of the pressing tool according to the invention, a spring constant of a spring element which presses the transport plate and the transport lever away from one another is smaller than the spring constant of the spring element which is retained on the spring-retaining web of the holding-down device.

As a result, the ferrules are effectively prevented from being pushed away together with the attachment from the crimping drum when the transport device moves away from the crimping drum.

In yet another embodiment, the holding-down device has two retaining arms with which the holding-down device is retained on side walls of the head cap of the tool head.

This enables simple fixing of the holding-down device at the head cap of the tool head.

In a further embodiment of the pressing tool according to the invention, a strip guide is arranged in a region of the depository.

Preferably, the strip guide is attached in a rear housing half of a housing of the first grip.

As a result, the ferrule is effectively prevented from falling out.

### BRIEF DESCRIPTION OF THE DRAWINGS

The invention will be explained in greater detail below using embodiments with the aid of the accompanying figures in which:

FIG. 1 is a side view of a pressing tool according to the invention;

FIG. 2 is a partial side perspective view of a section of a tool head, a grip recess of the first grip joined onto the tool head, a transport device arranged in the region of the tool head, and a holding-down device;

FIG. 3 is a side view of the arrangement depicted in FIG. 2;

FIG. 4 is a bottom perspective view of the tool head with a holding-down device removed;

FIG. 5 is a perspective view of the holding-down device;

FIG. 6 is a side perspective view of a portion of the tool head of FIG. 2 with a compression spring arranged on the holding-down device;

FIG. 7 is a perspective view of the holding-down device with a compression spring arranged thereon;

FIGS. 8 and 9 are perspective views of the tool head and holding-down device of FIGS. 6 and 7, respectively with a spring element being a leaf spring arranged on the holding-down device; and

FIG. 10 is an isometric view of a portion of a depository for storing ferrule strips with a strip guide arranged thereon.

### DETAILED DESCRIPTION

In the following description of the figures, terms such as top, bottom, left, right, front, rear, etc. relate exclusively to the exemplary depiction and position, selected in the respective figures, of the pressing tool, of the grip, of the crimping unit, crimping drum, transport device, transport plate, transport lever, holding-down device and the like. These terms should not be understood to be restrictive, i.e. these references may change through different working positions or the symmetrically identical design or the like.

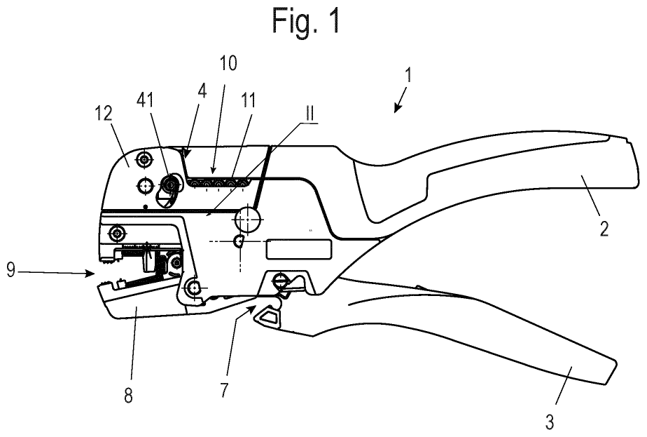

In FIG. 1, an embodiment variant of a pressing tool according to the invention is labelled overall with the reference number 1.

The pressing tool has two manual levers 2 and 3.

The upper manual lever 2 has a grip recess 21, which is mounted about a pivot axis 28 on a grip housing 27 which extends up into the region of a tool head 12 of the pressing tool 1.

The lower manual lever 3 is mounted pivotably on a lower region of the tool head 12.

Instead of actuating the pressing tool 1 by the manual levers 2, 3, it is also conceivable to design the pressing tool 1 as an automatic or semi-automatic pressing tool with a motor drive.

The pressing tool 1 has, in particular, a crimping unit 4, with a crimping drum 41 arranged in the tool head 12 of the pressing tool 1.

The crimping drum 41 has at least one crimping die. The crimping die is preferably mounted in a die receptacle of the crimping drum 41 in a sprung manner, in order to be able to process ferrules 11 with diameters of different sizes.

It is also conceivable to use a crimping drum with a number of crimping dies with different diameters, in order to be able to process ferrules 11 with diameters of different sizes.

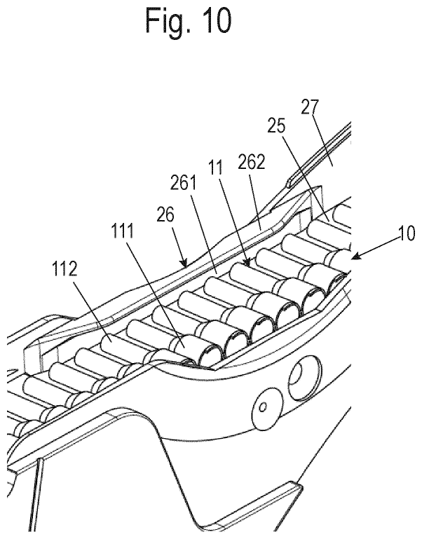

The crimping unit 4 furthermore includes a depository for storing a strip 10 of ferrules 11 connected to one another as a belt, as depicted by way of example in FIG. 10. Each of the ferrules 11 has a sleeve head 111 and a sleeve neck 112, wherein the sleeve neck 112 serves to receive wire ends freed from insulating material and the sleeve head 111 encloses the region of a conductor end of an electrical conductor at which the conductor wires are still surrounded with insulating material.

Regarding the mode of operation, in principle, of the pressing tool 1 and in particular of the crimping unit 4, we hereby refer to the disclosure in the above-mentioned DE 43 22 856 C1.

As can also be seen in FIG. 10, the ferrules 11 are connected to one another in the region of the sleeve head 111 by thin-walled webs to form a strip 10 of ferrules 11 connected to one another as a belt.

To store such a ferrule strip 10, a depository track 25 on which such a ferrule strip 10 rests is molded on the upper manual lever of the manual levers 2 in the grip housing 27.

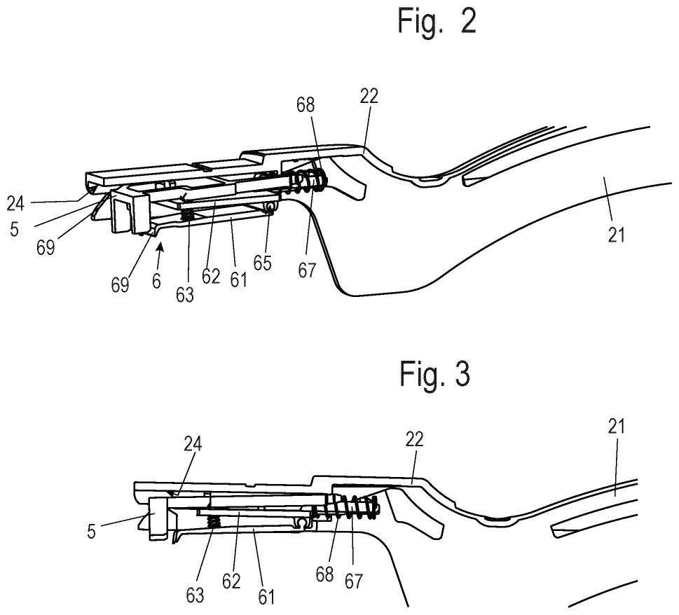

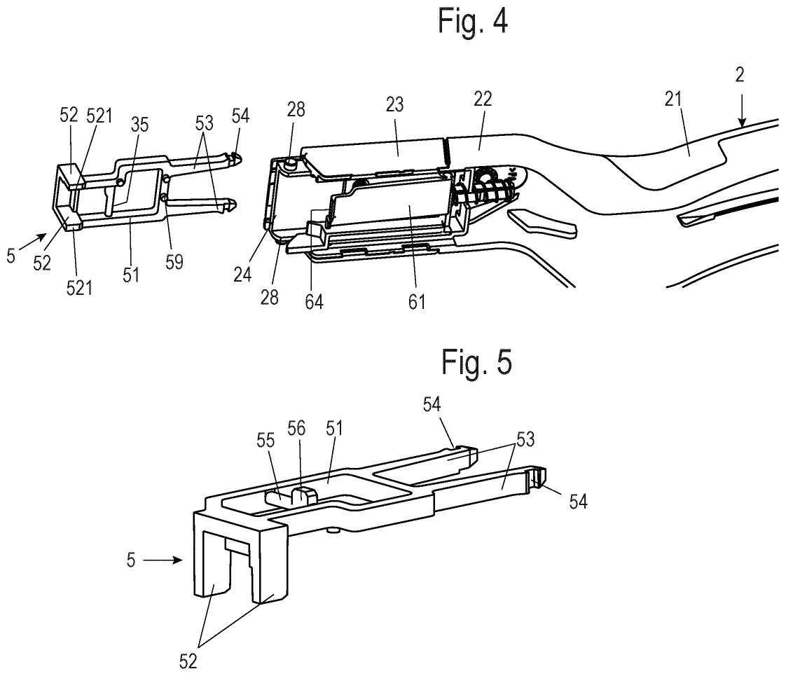

In order to move such a ferrule strip 10 toward the crimping drum 41, the pressing tool 1 has a transport device 6 which is movable in a prestressed manner in the direction of the crimping drum 41. This transport device 6 has, as is shown in FIGS. 2 to 4, a transport plate 62 and a transport lever 61 that is arranged pivotably and sprung relative to the transport plate.

The transport lever 61 has an attachment 64, close to the crimping drum 41, which can be pressed downwards in the direction of the depository track 25 between adjacent ferrules 11 of the strip 10.

The transport lever 61 is connected to the transport plate 62 via a pivot joint 65 at that end of the transport lever 61 which faces away from the attachment 64. In a region between the attachment 64 and the pivot joint 65, a mandrel 66, which extends through a recess in the transport plate 62 and which restricts a maximum pivot angle between the transport lever 61 and the transport plate 62, is molded on that surface of the transport lever 61 which faces the transport plate 62.

A compression spring 63, which prestresses the transport plate 62 relative to the transport lever 61 is placed on this mandrel, underneath the transport plate 62.

As can also be seen in FIGS. 2 to 4, the transport plate 62 extends further in the direction of the first manual lever 2 as a web-like extension 67, which is surrounded by an additional spring 68, here a compression spring, and which prestresses the entire transport device 6 toward the crimping drum 41.

In order to push the transport device 6 away from the crimping drum 41 toward the first manual lever 2, against the spring force of the spring 68, there is provided on the transport device 6 a run-on incline 69 on which there abuts a protrusion (not shown) which is provided in a rear side of the crimping drum 41 and which is guided along the run-on incline 69 when the crimping drum 41 is rotated about a crimping drum axis of rotation and pushes the transport device 6 away from the crimping drum 41 against the spring force of the spring 68.

In order to bring about a sufficient counter-push, depending on the size, i.e. diameter, of the ferrules 11, onto the ferrule strip 10 to perform a detachment process of the foremost of the ferrules 1 the pressing tool 1 has a holding-down device 5 which is arranged between the transport device 5 and a support surface 24 of the head cap 22 of the tool head 12.

The holding-down device 5 is upwardly spring supported on the support surface 24 and can thus press the transport plate 62 sufficiently against the transport lever 61 This sufficiently retains the ferrule strip 10 in its position and prevents the ferrule strip from pressing upwards during a detachment process of the foremost of the ferrules 11 from the ferrule arranged behind it when a blade pushes from below against the web between two adjacent ferrules 11. Without this, the foremost ferrule 11 would not be detached.

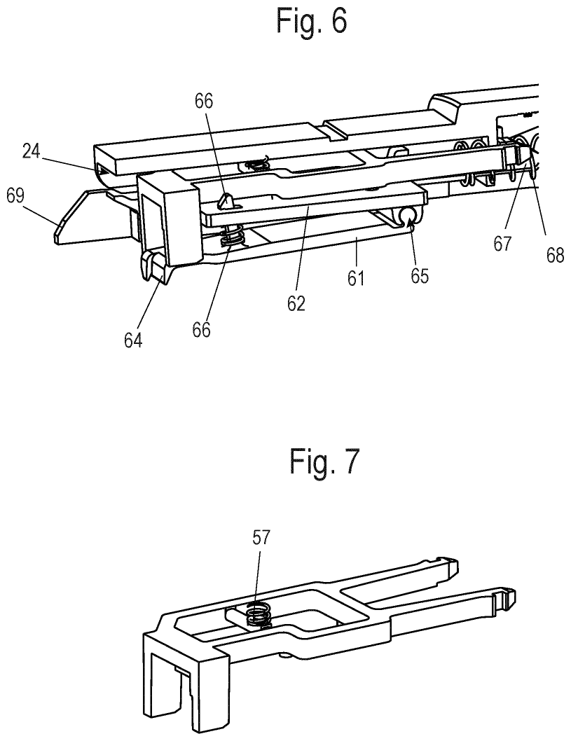

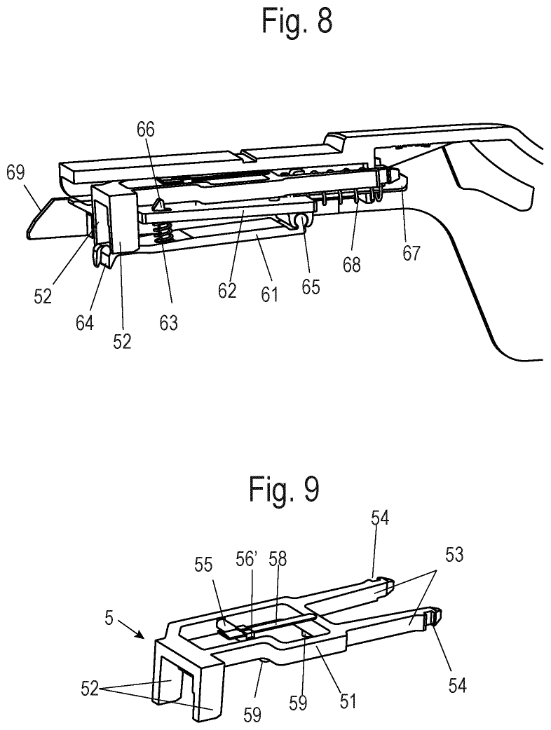

The holding-down device 5 shown in detail in FIGS. 5, 7 and 9 has a spring-retaining web 55, on which there is retained a spring element 57, 58 which is supported on the support surface 24 of the head cap 22 as is shown in FIGS. 6 and 8.

In the embodiment shown in FIGS. 6 and 7, the spring element 57 is a compression spring, which, placed over a spring retainer 56, in this instance a protrusion, is retained on the spring-retaining web 55.

In contrast, in the embodiment shown in FIGS. 8 and 9, the spring element 58 is a leaf spring, which is retained on the spring-retaining web 55 via a spring retainer 56′ configured like a bracket.

As is further shown in FIGS. 2 to 9, the holding-down device 5 has at least one arm, and in the embodiment shown here, two arms, 52 which, in a transport device's ferrule detachment position close to the crimping drum 41, as depicted by way of example in FIGS. 2 and 3, abuts the ferrule 11 adjacent to the ferrule 11 which is to be detached.

The spacing between the arms 52 of the holding-down device 5 is preferably of such a size that a press-on surface 521 of a shorter arm can press onto a shell surface of a sleeve head 111 of the ferrule 11 and a press-on surface 521 of a longer arm can press onto a shell surface of a sleeve neck 111 of the ferrule 11.

The holding-down device 5 also has a base body 51 from which on the one hand the arms 52 extend downwards vertically relative to the plane spanned by the base body 51. Two retaining arms 53 extend at that end of the base body 51, which is remote from the arms 52, in the plane of the base body. The holding-down device 5 is retained on side walls of the head cap 22 of the tool head 12 via the retaining arms.

For this purpose, respective grooves 54 are preferably provided at the ends of the retaining arms 53, which grooves 54 engage corresponding protrusions (not shown) on the side walls of the head cap 22.

Furthermore, protrusions 59 are preferably provided on the side of the base body 51 which faces the transport device 6. The protrusions press against the upper side of the transport plate 62.

The spring constant of the spring element 57, 58 fixed at the holding-down device 5 is preferably larger than the spring constant of the compression spring 63 which prestresses the transport lever 61 relative to the transport plate 62. This guarantees a sufficient counter-push exerted by the arms 52 of the holding-down device 5 during a detachment process of the foremost ferrule 11, and also enables sliding of the attachment 64 over the ferrules 11, which rest on the depository track 25, when the transport device 6 moves away from the crimping drum 41.

As can also be seen in FIG. 10, a strip guide 26 is arranged in the region of the depository 13.

The strip guide 26 is a guide web having a lateral guide 261 which extends parallel to the longitudinal extent of the strip 10 and on which the face sides of the sleeve necks 112 can abut. The strip guide further has a projection 262 which overlaps those ends of the sleeve necks 112, which are remote from the sleeve head 111, and thus prevents the ferrule strip 10 from falling out.

The strip guide 26 is preferably attached in the region of a rear housing half of a housing 27 of the first manual lever 2.

1-10. (canceled)

11. A pressing tool, comprising
two manual levers movable relative to one another;
a crimping unit having a crimping drum arranged in a tool head of the pressing tool and having at least one crimping die and a depository for storing a strip of ferrules connected to one another as a belt;
a transport device movable in a prestressed manner toward the crimping drum to transport the ferrule strip from the depository toward the crimping drum;
the transport device having a transport plate and a transport lever being pivotably arranged and sprung relative to the transport plate, the transport lever having an attachment close to the crimping drum and configured to be pressed between adjacent ferrules;
wherein
a holding-down device spring supported on the support surface to press the transport plate against the transport lever is arranged between the transport device and a support surface of a head cap of the tool head.

12. The pressing tool according to claim 11, wherein the holding-down device has a spring-retaining web having a spring element supported on the support surface of the head cap.

13. The pressing tool according to claim 12, wherein the spring element is a compression spring retained on a protrusion of the spring-retaining web.

14. The pressing tool according to claim 12, wherein the spring element is a leaf spring retained on the spring-retaining web via a spring retainer bracket.

15. The pressing tool according to claim 11, wherein the holding-down device has at least one arm arranged to abut a ferrule adjacent to a ferrule to be detached when the transport device is in a ferrule detachment position close to the crimping drum.

16. The pressing tool according to claim 15, wherein the holding-down device has two arms of different length, wherein a space between the arms is such that a press-on surface of a shorter arm can press onto a shell surface of a sleeve head of a ferrule and a press-on surface of a longer arm can press onto a shell surface of a sleeve neck of a ferrule.

17. The pressing tool according to claim 12, wherein a spring constant of a compression spring configured to press the transport plate and the transport lever away from one another is less than the spring constant of the spring element retained on the spring-retaining web of the holding-down device.

18. The pressing tool according to claim 15, wherein the holding-down device has two retaining arms to retain the holding-down device at side walls of the tool head cap.

19. The pressing tool according to claim 11, wherein a strip guide is arranged in the region of the depository.

20. The pressing tool according to claim 19, wherein the strip guide is attached in the region of a rear half of a housing of the first manual lever.
